(19) United States
(12) Patent Application Publication
(10) Pub. No.: US 2010/0258557 A1
(43) Pub. Date: Oct. 14, 2010

(54) IMAGE FORMING APPARATUS

(75) Inventors: Satoshi Kinouchi, Tokyo (JP); Kazuhiko Kikuchi, Kanagawa-ken (JP); Hiroshi Nakayama, Shizuoka-ken (JP); Hiroaki Yamauchi, Shizuoka-ken (JP); Shuji Yokoyama, Shizuoka-ken (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/755,015

(22) Filed: Apr. 6, 2010

Related U.S. Application Data
(60) Provisional application No. 61/168,154, filed on Apr. 9, 2009.

(51) Int. Cl. H05B 6/04

(52) U.S. Cl. 219/671

(57) ABSTRACT

A heating fuser includes: a rotating member configured to heat a toner transferred onto a sheet; a first coil body configured to generate a first magnetic field for inducing eddy-current in a first area including the center in a rotation axis direction of the rotating member; second coil bodies configured to generate second magnetic fields for inducing eddy-current in second areas of the rotating member adjacent to the first area in the rotation axis direction; third coil bodies located to extend over the first and second coil bodies when viewed in a direction orthogonal to the rotation axis direction; and a driving circuit configured to drive the third coil bodies between a first state in which the third coil bodies generate magnetic fields for weakening the first magnetic field and a second state in which the third coil bodies generate magnetic fields for strengthening the second magnetic fields.

### CROSS-REFERENCE TO RELATED APPLICATION

This application is based upon and claims the benefit of priority from: U.S. provisional application 61/168,154, filed on Apr. 9, 2009, the entire contents of each of which are incorporated herein by reference.

### TECHNICAL FIELD

This specification relates to a heating fuser and a heating method for heating a toner transferred onto a sheet.

### BACKGROUND

When a fuser of an electromagnetic induction heating system is caused to fix a toner image on small-size paper having size in an axis direction of a fixing roller smaller than that of the fixing roller, since heat in non-paper passing sections, which are areas not opposed to the small-size paper, is not deprived, in some case, the non-paper passing sections are overheated.

JP-A-2008-139475 discloses demagnetizing coils that weaken magnetic fluxes of a coil when a temperature rise in non-paper passing sections occurs.

### SUMMARY

This specification relates to a heating fuser including: a rotating member configured to heat a toner transferred onto a sheet; a first coil body configured to generate a first magnetic field for inducing eddy-current in a first area including the center in a rotation axis direction of the rotating member; second coil bodies configured to generate second magnetic fields for inducing eddy-current in second areas of the rotating member adjacent to the first area in the rotation axis direction; third coil bodies located to extend over the first and second coil bodies when viewed in a direction orthogonal to the rotation axis direction; and a driving circuit for driving the third coil bodies between a first state in which the third coil bodies generate magnetic fields for weakening the first magnetic field and a second state in which the third coil bodies generate magnetic fields for strengthening the second magnetic fields.

This specification relates to a rotating member heating method for heating, with a heating fuser, a rotating member configured to heat a toner transferred onto a sheet, the heating fuser including: a first coil body configured to generate a first magnetic field for inducing eddy-current in a first area including the center in a rotation axis direction of the rotating member; second coil bodies configured to generate second magnetic fields for inducing eddy-current in second areas of the rotating member adjacent to the first area in the rotation axis direction; and third coil bodies located to extend over the first and second coil bodies when viewed in a direction orthogonal to the rotation axis direction, the method including causing the third coil bodies to operate between a first state in which the third coil bodies generate magnetic fields for weakening the first magnetic field and a second state in which the third coil bodies generate magnetic fields for strengthening the second magnetic fields.

### DESCRIPTION OF THE DRAWINGS

FIG. 1 is a sectional view of an MFP apparatus;

FIGS. 2A and 2B are sectional views of a heating fuser;

FIG. 3 is a schematic diagram of a heating unit in which control coils are omitted;

FIG. 4 is a schematic diagram of the heating unit including the control coils;

FIG. 5 is a Y arrow view of FIG. 4;

FIG. 6 is a diagram for explaining a method of using the control coils;

FIG. 7 is a functional block diagram of a fuser; and

FIG. 8 is a circuit diagram for explaining a method of connecting the control coil.

### DETAILED DESCRIPTION

An embodiment of the present invention is explained below with reference to the accompanying drawings.

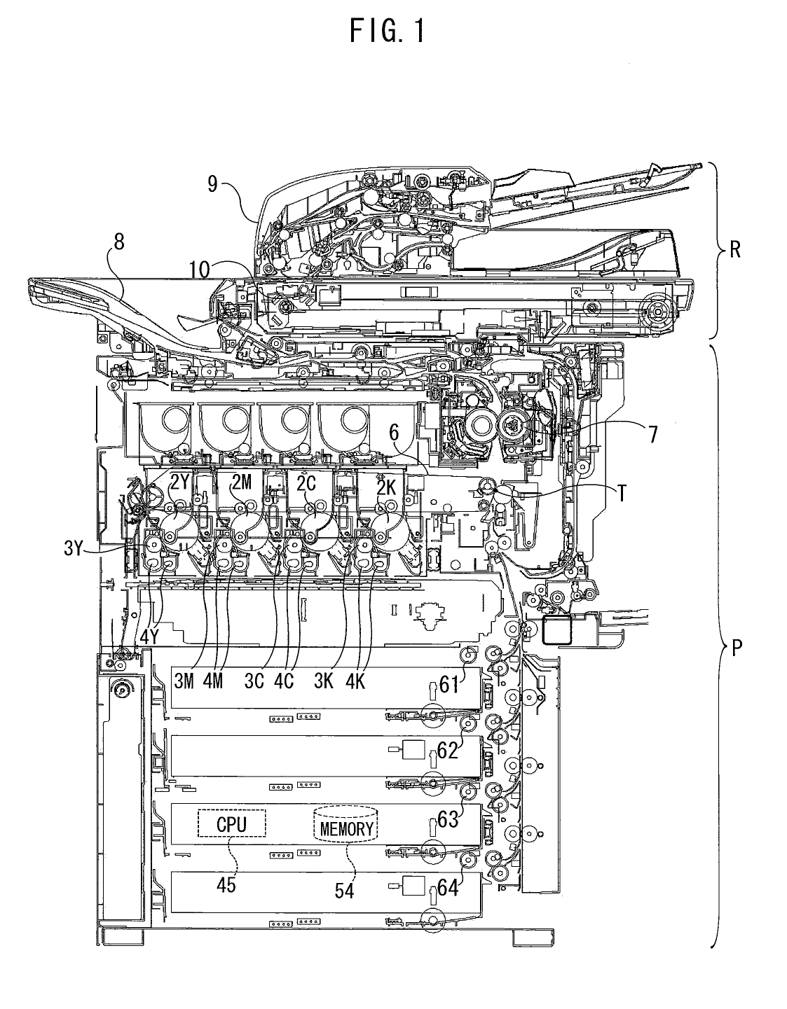

FIG. 1 is a longitudinal sectional view of an image forming apparatus (MFP: Multi Function Peripheral). An image forming apparatus 1 includes an image reading unit R and an image forming unit P.

The image reading unit R scans and reads images of a sheet original document and a book original document.

The image forming unit P forms a developer image on a sheet on the basis of, for example, an image read from an original document by the image reading unit R or image data transmitted from an external apparatus to the image forming apparatus 1.

The image reading unit R includes an auto document feeder (ADF) 9. The image reading unit R reads an image of an original document conveyed by the auto document feeder 9 or an original document placed on a document table.

The image forming unit P includes pickup rollers 61 to 64, photoconductive members 2Y to 2K, developing rollers 3Y to 3K, mixers 4Y to 4K, an intermediate transfer belt 6, a heating fuser 7, and a discharge tray 8.

A CPU 45 performs various kinds of processing in the image forming apparatus 1. The CPU 45 executes computer programs stored by a memory 54 to thereby realize various functions.

The memory 54 may be, for example, a RAM (Random Access Memory), a ROM (Read Only Memory), a DRAM (Dynamic Random Access Memory), an SRAM (Static Random Access Memory), or a VRAM (Video RAM).

As an example of the heating fuser 7, an overview of copy processing performed when the heating fuser 7 is mounted on the image forming apparatus 1 is explained below.

First, sheets picked up from cassettes by the pickup rollers 61 to 64 enter a sheet conveying path. The sheets that enter the sheet conveying path are conveyed in a predetermined conveying direction by plural roller pairs.

The image reading unit R reads images of plural sheet original documents.

Electrostatic latent images are formed, on the basis of image data of the images read from the original documents by the image reading unit R, on photoconductive surfaces of the photoconductive members 2Y, 2M, 2C, and 2K for transferring developer images of yellow (Y), magenta (M), cyan (C) and black (K) onto a sheet.

Subsequently, developers agitated by the mixers 4Y to 4K in developing devices are supplied to the photoconductive members 2Y to 2K, on which the electrostatic latent images are formed, by the developing rollers 3Y to 3K. Consequently, the electrostatic latent images formed on the photoconductive surfaces of the photoconductive members 2Y to 2K are visualized.

The developer images formed on the photoconductive members 2Y to 2K in this way are transferred onto a belt surface of the intermediate transfer belt 6 (so-called primary transfer). The developer images conveyed according to the rotation of the intermediate transfer belt 6 are transferred onto the conveyed sheets in a predetermined secondary transfer position T.

The developer images transferred onto the sheets are heated and fixed on the sheets in the heating fuser 7. The sheets having the developer images heated and fixed thereon are conveyed through a conveying path by plural conveying roller pairs and sequentially discharged onto the discharge tray 8.

Details of the heating fuser 7 according to this embodiment are explained below.

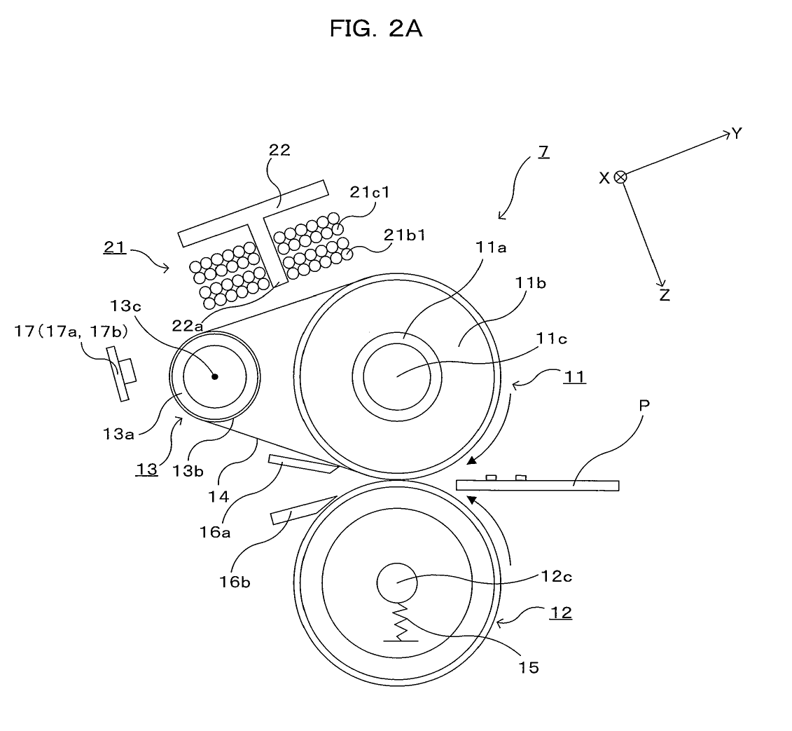

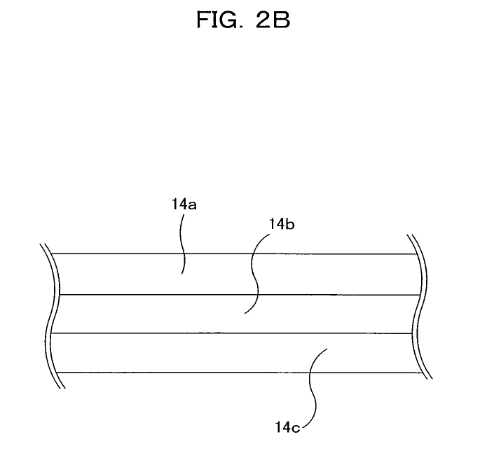

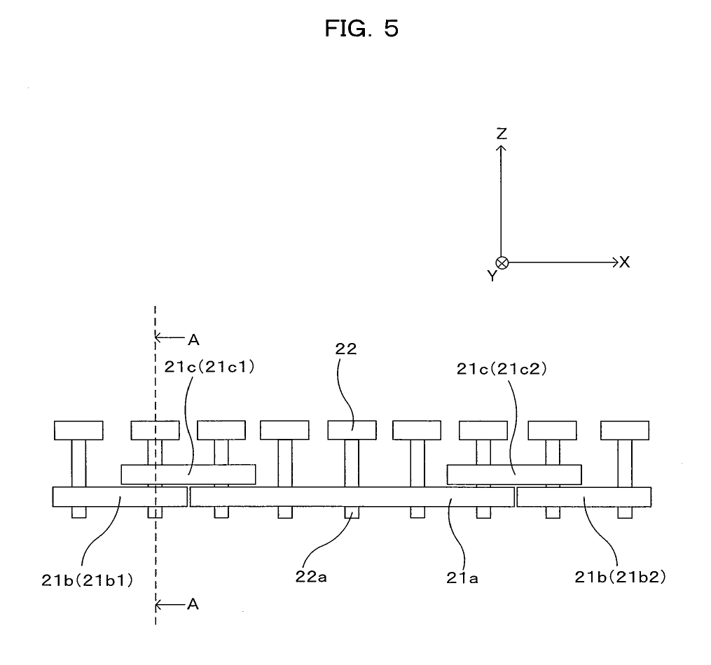

FIG. 2A is a sectional view of the heating fuser 7. An X axis, a Y axis, and a Z axis are different three axes orthogonal to one another. The X axis indicates a rotation axis direction of a heating roller 11 and the Z axis indicates a direction in which a center coil 21a and control coils 21c are opposed to each other. A relation among the X axis, the Y axis, and the Z axis is the same in the other drawings. A heating unit 21 corresponds to an A-A section of the heating unit 21 shown in FIG. 5.

The heating fuser 7 includes the heating roller 11 (φ50 mm), a pressing roller 12 (φ50 mm), a satelite roller 13 (φ18 mm), a heating belt (a rotating member) 14, and the heating unit 21.

The pressing roller 12 is rotated in an arrow direction by a driving motor. The heating roller 11, the satelite roller 13, and the heating belt 14 rotate in an arrow direction following the rotation of the pressing roller 12. The heating belt 14 is sandwiched by the heating roller 11 and the pressing roller 12. A rotating shaft section 12c of the pressing roller 12 bears a pressing mechanism 15. The pressing mechanism 15 presses the pressing roller 12 against the heating roller 11. A sheet P enters a nip section of the pressing roller 12 and the heating roller 11 and nipped and pressed by the pressing roller 12 and the heating belt 14.

The satelite roller 13 is located further on a downstream side in a conveying direction of the sheet P than the heating roller 11. The satelite roller 13 rotates in the arrow direction (a clockwise direction) around a rotating shaft section 13c. A rotating shaft section 11c of the heating roller 11 and the rotating shaft section 13c of the satelite roller 13 are parallel to each other. The heating belt 14 is wound and suspended around the heating roller 11 and the satelite roller 13. The heating unit 21 is arranged to be opposed to the heating belt 14 and heats the heating belt 14.

The heating roller 11 includes, from the inner side to the outer side in a radial direction thereof, a cored bar layer 11a formed of a cored bar and a foamed rubber layer 11b formed of foamed rubber (sponge) in this order. The thickness of the cored bar layer 11a may be 2 mm. The thickness of the foamed rubber layer 11b may be 5 mm.

FIG. 2B is a sectional view in a thickness direction of the heating belt 14. The heating belt 14 includes, from the inner side to the outer side in a radial direction thereof, a metal conductive layer 14a, a solid rubber layer 14b, and a release layer 14c in this order. The metal conductive layer 14a may be formed of nickel having thickness of 40 μm. The metal conductive layer 14a may be formed of stainless steel, aluminum, a composite material of stainless steel and aluminum, or the like. The solid rubber layer 14b may be formed of silicon rubber having thickness of 200 μm. The release layer 14c may be formed of a PFA tube having thickness of 30 μm.

The pressing roller 12 includes silicon rubber, fluorine rubber, or the like around a layer formed of a cored bar.

The satelite roller 13 includes a metal pipe 13a and a coating layer 13b on the surface of the metal pipe 13a. Aluminum can be used for the metal pipe 13a. Iron, copper, stainless steel, or the like can also be used for the metal pipe 13a. A heat pipe or the like having higher heat conductivity can be used instead of the metal pipe 13a.

When the sheet P passes a fixing point that is a press contact section (a nip section) of the heating belt 14 and the pressing roller 12, a developer on the sheet P can be fusion-bonded, compression-bonded, and fixed.

A peeling blade 16a is provided on the circumference of the heating belt 14 further on the downstream side in the rotating direction than the nip section of the heating belt 14 and the pressing roller 12. The peeling blade 16a comes into contact with the sheet P, whereby the sheet P is peeled off from the belt surface of the heating belt 14.

A peeling blade 16b is provided further on the downstream side in the rotating direction than the nip section of the heating belt 14 and the pressing roller 12. The peeling blade 16b comes into contact with the sheet P, whereby the sheet P is peeled off from the belt surface of the pressing roller 12.

A temperature detecting unit 17 detects the temperature of the heating belt 14. The temperature detecting unit 17 includes a center-temperature detecting unit 17a configured to detect the temperature of a center area (a first area) including the center in the width direction of the heating belt 14 (a rotation axis direction of the heating belt 14) and an end-temperature detecting unit 17b configured to detect the temperature of an end area (a second area) of the heating belt 14 adjacent to the center area in the width direction. The center-temperature detecting unit 17a and the end-temperature detecting unit 17b are located in positions in the rotation axis direction of the heating belt 14 different from each other.

A non-contact temperature sensor can be used for the temperature detecting unit 17. A temperature sensor of a thermopile type can be used as the non-contact temperature sensor.

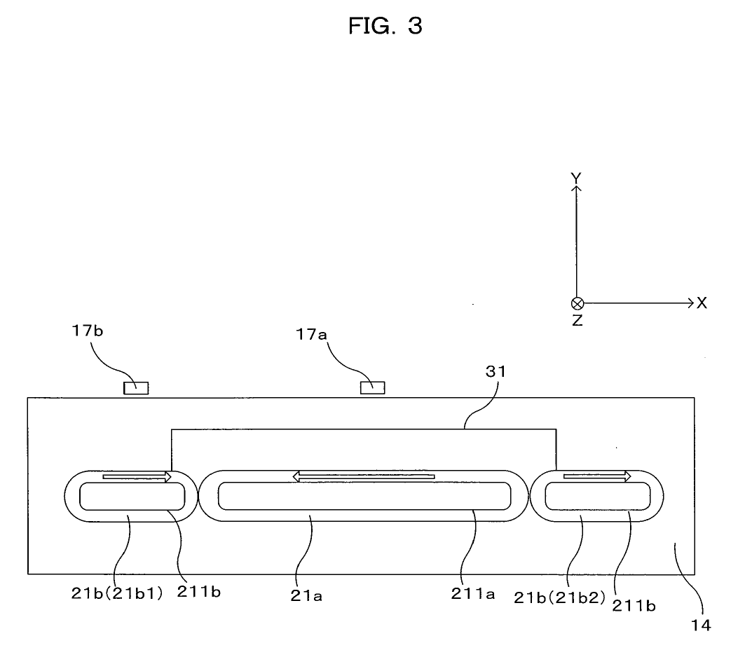

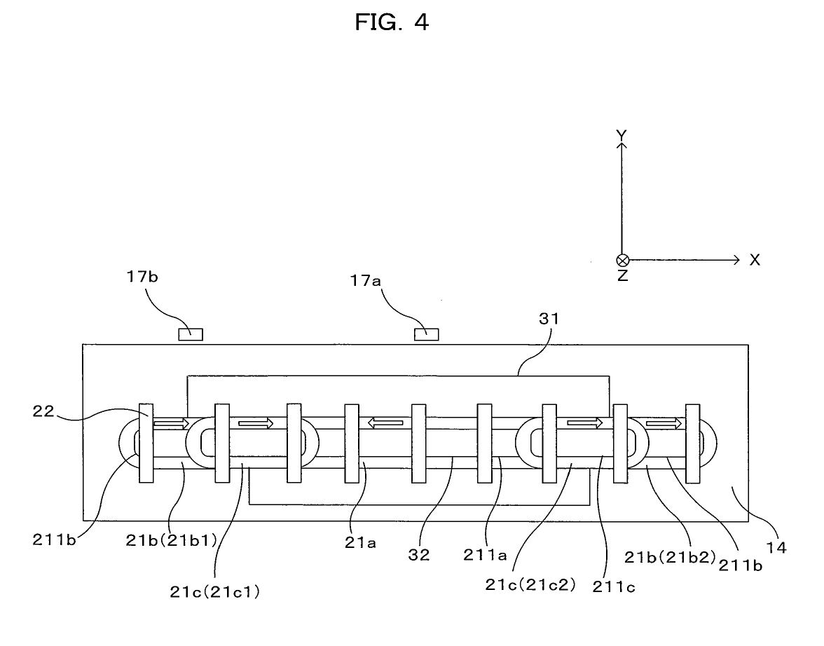

The configuration of the heating unit 21 is explained in detail with reference to FIGS. 3, 4, and 5. FIG. 3 is a plan view of the heating unit 21 in which the control coils 21c and magnetic cores 22 are omitted. FIG. 4 is a plan view of the heating unit 21 including the control coils 21c and the magnetic cores 22. Arrows shown in FIGS. 3 and 4 indicate winding directions of coils.

The heating unit 21 includes the center coil (a first coil body) 21a, end coils (second coil bodies) 21b, and the control coils (third coil bodies) 21c. The heating unit 21 heats the heating belt 14 with induction heating. The center coil 21a induction-heats the center area (the first area) including the center in the width direction of the heating belt 14. The end coils 21b include a left side coil 21b1 and a right side coil 21b2. In the following explanation, the left side coil 21b1 and the right side coil 21b2 are collectively referred to as end coils 21b.

The left side coil 21b1 is located in a position adjacent to the center coil 21a in one direction of the X axis direction. The right side coil 21b2 is located in a position adjacent to the center coil 21a in the other direction of the X axis direction.

The end coils 21b heat end areas of the heating belt 14. The end areas mean areas on both sides in the X axis direction of the center area. A criterion for dividing the center area and the end areas is decided in terms of design according to a type of the size of the sheet P to be fed. The left side coil 21b1 is connected to the right side coil 21b2 in series by a conductive wire 31.

The control coils 21c include a left side control coil 21c1 and a right side control coil 21c2. In the following explanation, the left side control coil 21c1 and the right side control coil 21c2 are collectively referred to as control coils 21c.

The left side control coil 21c1 is located in a position corresponding to an intermediate position between the center coil 21a and the left side coil 21b1 when viewed in a direction of the Z axis. The right side control coil 21c2 is located in a position corresponding to an intermediate position between the center coil 21a and the right side coil 21b2 when viewed in the direction of the Z axis. The left side control coil 21c1 is connected to the right side control coil 21c2 in series by a conductive wire 32.

The center coil 21a has an opening 211a in the center thereof. The end coils 21b have openings 211b. The control coils 21c have openings 211c.

As shown in FIG. 5, plural magnetic cores 22 are arranged in the X axis direction. The magnetic cores 22 are T-shaped in a Y-Z section. Leg sections 22a of the magnetic cores 22 extend toward the insides of the openings 211a to 211c of the center coil 21a, the end coils 21b, and the control coils 21c. The magnetic cores 22 strengthen magnetic force formed by the center coil 21a, the end coils 21b, and the control coils 21c.

As shown in FIGS. 3 and 4, winding directions of the center coil 21a and the end coils 21b are opposite to each other. The winding direction of the center coil 21a is the counterclockwise direction when the paper surface is viewed from the Z axis direction. The winding direction of the end coils 21b is the clockwise direction when the paper surface is viewed from the Z axis direction. The winding direction of the control coils 21c is the same as that of the end coils 21b.

Each of the center coil 21a, the end coils 21b, and the control coils 21c may be a Litz wire obtained by binding plural (e.g., sixteen) copper wire materials. The radial dimension of the copper wire materials is, for example, 0.5 mm. The wire diameter can be set smaller than penetration depth and AC current can be effectively fed by using the Litz wire. A coating wire for the coils may be heat resistant polyamide imide.

The center coil 21a and the end coils 21b are selectively alternately driven at a rate of fixed time on the basis of detected temperatures of the center-temperature detecting unit 17a and the end-temperature detecting unit 17b. Therefore, the center coil 21a and the end coils 21b are not simultaneously driven. The heating belt 14 is heated, whereby fixing control temperature can be maintained.

Magnetic fluxes and eddy-current are generated, to prevent a change in a magnetic field, in areas of the heating belt 14 opposed to the center coil 21a and the end coils 21b by magnetic fluxes generated by high-frequency current applied to the center coil 21a and the end coils 21b. Joule heat is generated by the eddy-current and the resistance of the heating belt 14. The heating belt 14 is heated. The frequency of the high-frequency current flowing to the center coil 21a and the end coils 21b may be 20 kHz to 100 kHz. Power may be changed in a range of 200 W to 1500 W by changing a driving frequency of an inverter circuit.

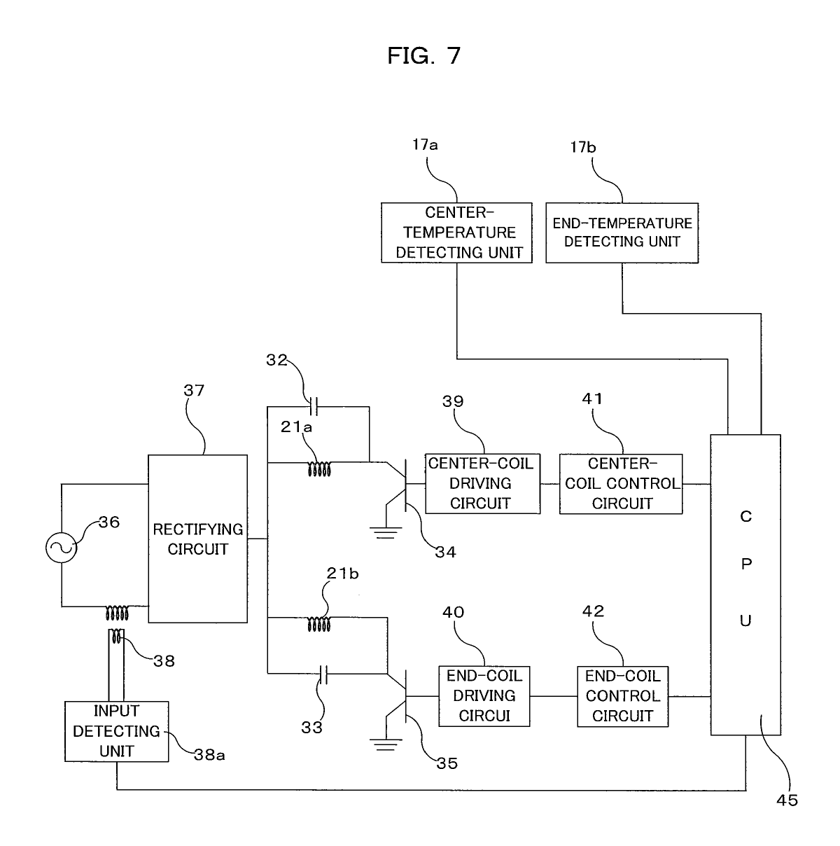

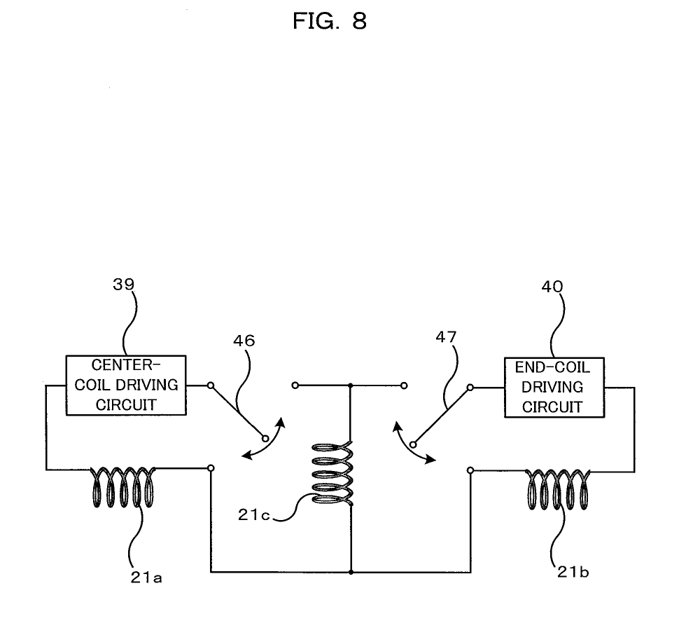

FIG. 7 is a functional block diagram of the heating fuser 7. FIG. 8 is a circuit diagram of a switching configuration for the control coil 21c.

Resonant capacitors 32 and 33 are respectively connected in parallel to each other to the center coil 21a and the end coil 21b. The inverter circuit includes resonant circuits of the capacitors 32 and 33 and switching elements 34 and 35 respectively connected to the resonant circuits. The switching elements 34 and 35 may be IGBTs or MOS-FETs used at high withstanding voltage and large current.

The center coil 21a is connected to a first changeover switch 46. The CPU 45 changes over the first changeover switch 46 to a first state in which the center coil 21a and the control coil 21c are connected in series to each other and a third state in which the center coil 21a and the control coil 21c are not connected. In the first state, the control coil 21c weakens a magnetic field formed by the center coil 21a.

The end coil 21b is connected to a second changeover switch 47. The CPU 45 changes over the second changeover switch 47 to a second state in which the end coil 21b and the control coil 21c are connected in series to each other and the third state in which the end coil 21b and the control coil 21c are not connected. In the second state, the control coil 21c strengthens a magnetic field formed by the end coil 21b.

The inverter circuit uses DC power obtained by a rectifying circuit 37 smoothing a commercial AC power supply 36. A transformer 38 detects total power consumption via an input detecting unit 38a at a pre-stage of the rectifying circuit 37. A center-coil driving circuit 39 drives the switching element 34 according to the control by a center-coil control circuit 41. An end-coil driving circuit 40 drives the switching element 35 according to the control by an end-coil control circuit 42. The center-coil driving circuit 39 drives the switching element 34 in a range of, for example, 20 kHz to 100 kHz. The end-coil driving circuit 40 drives the switching element 35 in a range of, for example 20 kHz to 100 kHz.

The CPU 45 controls the center-coil control circuit 41 and the end-coil control circuit 42 on the basis of the temperatures detected by the temperature detecting units 17a and 17b.

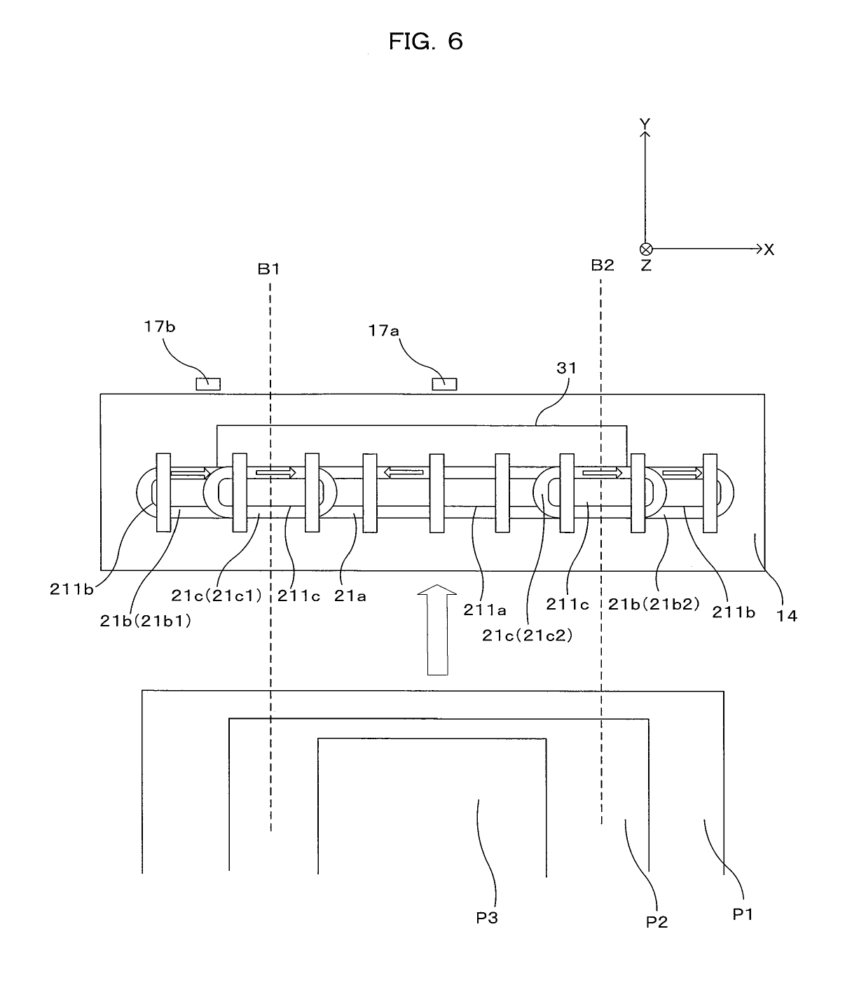

FIG. 6 is a schematic diagram of a positional relation between a passing sheet and the coils 21a to 21c configured to heat the sheet via the heating belt 14. Dotted lines B1 and B2 indicate boundaries between the center coil 21a and the end coils 21b. Wide paper P1 has size in the rotation axis direction of the heating belt 14 substantially the same as the total size of the center coil 21a and the end coils 21b. Medium paper P2 has size in the rotation axis direction of the heating belt 14 smaller than that of the wide paper P1 and larger than that of the center coil 21a. Narrow paper P3 has size in the rotation axis direction of the heating belt 14 smaller than that of the center coil 21a. The wide paper P1 may be paper of the A3 or A4 size. The medium paper P2 may be the A4-R or B4 paper. The narrow paper P3 may be the A5 or ST-R paper.

The CPU 45 may detect the size of a sheet using a sensor provided in a cassette tray. The CPU 45 may detect the size of a sheet using a sensor arranged in a conveying path for conveying the sheet.

The operation of the heating unit 21 in heating the wide paper P1 is explained below. The CPU 45 sets the first changeover switch 46 in the third state in which the center coil 21a and the control coils 21c are not connected. The CPU 45 sets the second changeover switch 47 in the third state in which the end coils 21b and the control coils 21c are not connected. Therefore, the center coil 21a and the end coils 21b are alternately driven and the control coils 21c are not driven.

The CPU 45 determines driving ratios of the center coil 21a and the end coils 21b on the basis of temperature information acquired by the center-temperature detecting unit 17a and the end-temperature detecting unit 17b.

The operation of the heating unit 21 in heating the medium paper P2 is explained below.

When the heating belt 14 is divided into a paper passing area where the medium paper P2 passes and non-paper passing areas where the medium paper P2 does not pass, as shown in FIG. 6, the center-temperature detecting unit 17a detects the temperature of the paper passing area and the end-temperature detecting unit 17b detects the temperature of the non-paper passing areas. When the medium paper P2 passes the heating belt 14, the heat of the paper passing area is deprived and the heat of the non-paper passing areas is hardly deprived. Therefore, in the center coil 21a and the end coils 21b, the driving ratio of the center coil 21a is relatively high. Therefore, a temperature rise in the non-paper passing areas of the heating belt 14 is suppressed.

However, a coil has a characteristic that a magnetic field is relatively weaker on end sides than on a center side. Therefore, if the driving ratio of the center coil 21a is relatively high, temperature falls in paper passing areas corresponding to inter-coil areas between the center coil 21a and the end coils 21b (i.e., areas including the boundaries E1 and B2).

If the driving ratio of the center coil 21a and the driving ratio of the end coils 21b are equal, the paper passing areas corresponding to the inter-coil area are heated to temperature same as the temperature of the other paper passing area by a heat generation effect of both the center coil 21a and the end coils 21b. However, if the driving ratio of the center coil 21a is relatively high, the heat generation effect of the end coil 21b decreases and the temperature of the paper passing areas corresponding to the inter-coil areas falls. As a result, a fixing failure of a toner is likely to occur in the areas corresponding to the inter-coil areas in the medium paper P2.

The CPU 45 drives the second changeover switch 47 to connect the end coils 21b and the control coils 21c in series to each other (the second state). Since the winding directions of the end coils 21b and the control coils 21c are the same, magnetic fields in the inter-coil areas are strengthened. When the magnetic fields in the inter-coil areas are strengthened, the areas corresponding to the inter-coil areas in the heating belt 14 are heated. Therefore, temperature fluctuation in the entire paper passing area can be suppressed. Further, the CPU 45 drives the heating unit 21 under a condition that the driving ratio of the center coil 21a is relatively high. Therefore, fluctuation in the temperature of the entire heating belt 14 is suppressed. The medium paper P2 is a sheet that is comparatively frequently used. Therefore, thermal efficiency of the center coil 21a, the end coils 21b, and the control coils 21c is improved.

In a heating system in the past in which only the center coil 21a heats the wide paper P1, demagnetizing coils arranged in positions corresponding to both ends of the center coil 21a weaken magnetic fluxes of the center coil 21a to suppress a temperature rise.

However, in the heating system in the past, a lot of energy is necessary to cancel the magnetic fluxes of the center coil 21a. Therefore, efficiency is low compared with a heating system in which the center coil 21a is driven only for the purpose of heating.

In this embodiment, since the driving ratio of the end coils 21b is relatively low, heating efficiency in heating the medium paper P2 having relatively high frequency of use is suppressed from falling.

The operation of the heating unit 21 in heating the narrow paper P3 is explained below. An area opposed to the center coil 21a in the heating belt 14 is divided into a paper passing area where the narrow paper P3 passes and non-paper passing areas where the narrow paper P3 does not pass. Areas opposed to the end coils 21b in the heating belt 14 are the non-paper passing areas. Therefore, the driving ratio of the center coil 21a is higher than that of the end coils 21b. Consequently, the temperature of the non-paper passing areas opposed to the center coil 21a is higher than that of the paper passing area.

The CPU 45 drives the first changeover switch 46 to connect the center coil 21a and the control coils 21c in series to each other (the first state). Since the winding directions of the center coil 21a and the control coils 21c are opposite to each other, magnetic fields at the ends of the center coil 21a are weakened. When the magnetic fields at the ends of the center coil 21a are weakened, temperature fluctuation in the heating belt 14 is suppressed.

### Modification

In the embodiment explained above, the control coils 21c are selectively connected to one driving circuit of the center coil 21a and the end coils 21b. However, the control coils 21c may be connected to an independent driving circuit.

In the embodiment, the number of the center coil 21a is one and the number of the end coils 21b is two. However, the number of the end coils 21b may be increased to 2n (n is a natural number equal to or larger than 2).

In the embodiment, a heating target of the heating unit 21 is the heating belt 14. However, the heating target may be a fixing roller.

In the embodiment, the number of the temperature detecting units 17 is two. However, the number of the temperature detecting units 17 may be three or more.

What is claimed is:

1. A heating fuser comprising:
a rotating member configured to heat a toner transferred onto a sheet;
a first coil body configured to generate a first magnetic field for inducing eddy-current in a first area including a center in a rotation axis direction of the rotating member;
second coil bodies configured to generate second magnetic fields for inducing eddy-current in second areas of the rotating member adjacent to the first area in the rotation axis direction;
third coil bodies located to extend over the first and second coil bodies when viewed in a direction orthogonal to the rotation axis direction; and
a driving circuit configured to drive the third coil bodies between a first state in which the third coil bodies generate magnetic fields for weakening the first magnetic field and a second state in which the third coil bodies generate magnetic fields for strengthening the second magnetic fields.

2. The fuser according to claim 1, wherein the driving circuit drives the third coil bodies among the first state, the second state, and a third state in which electric current does not flow.

3. The fuser according to claim 2, wherein
winding directions of the first coil body and the third coil bodies are opposite to each other,
winding directions of the second coil bodies and the third coil bodies are the same, and
the driving circuit electrically connects the first and third coil bodies in series to each other in the first state and electrically connects the second and third coil bodies in series to each other in the second state.

4. The fuser according to claim 3, wherein
the driving circuit includes a first driving circuit configured to drive the first coil body and a second driving circuit configured to drive the second coil bodies,
the device further comprises:
a first temperature-information acquiring unit configured to acquire information concerning temperature of the first area of the rotating member;
a second temperature-information acquiring unit configured to acquire information concerning temperature of the second areas of the rotating member;
a controller configured to perform, on the basis of temperature information acquired by the first and second temperature-information acquiring units, control for alternately driving the first and second driving circuits;
a first switch for performing switching between the first state in which the third coil bodies and the first driving circuit are connected and the third state in which the third coil bodies and the first driving circuit are unconnected; and
a second switch for performing switching between the second state in which the third coil bodies and the second driving circuit are connected and the third state in which the third coil bodies and the second driving circuit are unconnected, and
the controller sets the first switch in the first state when the device applies heating and fixing to a narrow sheet having size in the rotation axis direction smaller than that of the first area and sets the second switch in the second state when the device applies heating and fixing to a medium sheet having size in the rotation axis direction larger than that of the first area and smaller than that of an overall area including the first and second areas.

5. The fuser according to claim 4, wherein the controller sets the first and second switches in the third state when the device applies heating and fixing to a wide sheet having size in the rotation axis direction larger than that of the medium sheet.

6. The fuser according to claim 4, wherein the second temperature-information acquiring unit acquires temperature information of non-passing areas where the medium sheet does not pass in the second areas.

7. The fuser according to claim 4, wherein the first temperature-information acquiring unit acquires temperature information of a passing area where the narrow sheet passes in the first area.

8. The fuser according to claim 4, wherein the third coil bodies extend out to areas opposed to non-passing areas where the narrow sheet does not pass in the first area.

9. The fuser according to claim 1, wherein the first to third coil bodies respectively include coil wires wound in a spiral shape around openings of the first to third coil bodies.

10. The fuser according to claim 9, wherein the openings of the first to third coil bodies are arranged side by side in the rotation axis direction when viewed in a direction of the openings.

11. The fuser according to claim 1, wherein the rotating member is a belt member that endlessly rotates.

12. A method heating, with a heating fuser, a rotating member configured to heat a toner transferred onto a sheet, the heating fuser including: a first coil body configured to generate a first magnetic field for inducing eddy-current in a first area including a center in a rotation axis direction of the rotating member; second coil bodies configured to generate second magnetic fields for inducing eddy-current in second areas of the rotating member adjacent to the first area in the rotation axis direction; and third coil bodies located to extend over the first and second coil bodies when viewed in a direction orthogonal to the rotation axis direction,
the method comprising causing the third coil bodies to operate between a first state in which the third coil bodies generate magnetic fields for weakening the first magnetic field and a second state in which the third coil bodies generate magnetic fields for strengthening the second magnetic fields.

13. The method according to claim 12, further comprising causing the third coil bodies to operate among the first state, the second state, and a third state in which electric current does not flow.

14. The method according to claim 13, wherein
winding directions of the first coil body and the third coil bodies are opposite to each other,
winding directions of the second coil bodies and the third coil bodies are the same, and
the method further comprises electrically connecting the first and third coil bodies in series to each other in the first state and electrically connecting the second and third coil bodies in series to each other in the second state.

15. The method according to claim 14, further comprising setting the third coil bodies in the first state in applying heating and fixing to a narrow sheet having size in the rotation axis direction smaller than that of the first area and setting the third coil bodies in the second state in applying heating and fixing to a medium sheet having size in the rotation axis direction larger than that of the first area and smaller than that of an overall area including the first and second areas.

16. The method according to claim 15, further comprising setting the third coil bodies in the third state in applying heating and fixing to a wide sheet having size in the rotation axis direction larger than that of the medium sheet.

17. The method according to claim 16, further comprising alternately driving the first coil body and the second coil bodies.

18. The method according to claim 17, further comprising performing the driving on the basis of temperature information of the first area and the second areas.

19. The method according to claim 18, wherein the temperature information of the second area is temperature information of non-passing areas where the medium sheet does not pass in the second areas.

20. The method according to claim 18, wherein the temperature information of the first area is temperature information of a passing area where the narrow sheet passes in the first area.
